(19) United States
(12) Patent Application Publication
(10) Pub. No.: US 2018/0065468 A1
(43) Pub. Date: Mar. 8, 2018

(54) WHEEL RIM FOR MOTOR VEHICLES DRIVEN WITH WHEEL HUB MOTORS

(71) Applicant: KSM Castings Group GmbH, Hildesheim (DE)

(72) Inventor: Stefan GEISLER, Sarstedt (DE)

(73) Assignee: KSM Castings Group GmbH, Hildesheim (DE)

(21) Appl. No.: 15/554,061

(22) PCT Filed: Mar. 3, 2016
(86) PCT No.: PCT/DE2016/100097

§ 371 Date: Aug. 28, 2017

(30) Foreign Application Priority Data
Mar. 25, 2015 (DE) 10 2015 104 457.9

(51) Int. Cl. B60K 7/00; H02K 7/14

(52) U.S. Cl. CPC B60K 7/0007; B60K 2007/0092; B60K 2007/0038; H02K 7/14

(57) ABSTRACT

A wheel rim for motor vehicles driven with wheel hub motors has a wheel rim base, an outer and an inner wheel rim flange, and a wheel disk having a center hole, attachment holes, and, if applicable, having spokes. At least a part of the rotor housing of a wheel hub motor forms at least a part of the wheel rim.

The invention relates to a wheel rim for motor vehicles driven with wheel hub motors, in accordance with the preamble of claim 1.

It is known to install an electric motor as a wheel hub motor in the interior of a wheel rim. The wheel hub motor has an electric motor having a rotor as well as a stator, wherein the rotor stands in interaction with the stator for generation of a motor torque, and wherein the rotor is disposed so as to rotate about a main axis of rotation relative to the stator. The stator is disposed in torque-proof manner relative to the vehicle. The rotor, in contrast, is connected with a wheel in torque-proof manner. It is known that the rotor and the wheel overlap in the radial direction relative to the main axis of rotation. The wheel is particularly connected with the rotor directly.

Wheel hub motors are used in electric motor vehicles in different embodiments, wherein the drive moment is transferred to a driven wheel not by way of a transmission, but rather the driven wheel is directly connected with the rotor of the wheel hub motor. For example, DE 10 2006 040 220 A1, DE 10 2008 019 974 B4 or DE 10 2013 202 592 A1 disclose wheel hub motors for motor vehicles.

A known wheel hub motor is an electric motor of an outer rotor type, in which a rotor is disposed on the outside of a stator. The rotor comprises a rotor housing having a ring-shaped structure and permanent magnets, which are affixed on the inside circumference of the rotor housing. The rotor housing is disposed in the interior of the wheel rim, wherein the rotor is configured as an outer rotor.

Proceeding from this state of the art, the invention is based on the task of optimizing a wheel rim for motor vehicles operated with wheel hub motors, particularly in terms of design.

According to the invention, this task is accomplished by means of a wheel rim having the characteristics of claim 1. Preferred or advantageous embodiments of the invention are evident from the dependent claims, the following description, and the attached figures.

A wheel rim for motor vehicles driven with wheel hub motors, comprising a wheel rim base, an outer and an inner wheel rim flange, and a wheel disk having a center hole, attachment holes, and, if applicable, spokes, is characterized, according to the invention, in that at least a part of the rotor housing of the wheel hub motor forms at least a part of the wheel rim.

By means of this astonishingly simple measure, new free space or construction space is created in comparison with a conventional wheel rim, which accommodates a rotor housing as such in its interior, for example for useful components of the wheel hub motor. Because of the additional amount of free space or construction space, wheel hub motors having greater power can be made available. The rotor housing more or less takes on the function of the wheel rim for this purpose, at least in part.

Because wheel replacement cannot be carried out easily in the case of this type of wheel rim configuration, according to the invention, it can be advantageous if the wheel rim is configured in such a manner that a tire having emergency running properties, called a run-flat tire, can be put onto the wheel rim according to the invention.

It can be advantageous if at least part of the rotor housing forms the wall of the ring-shaped wheel rim base, at least in part. In this way, additional free space or construction space is created in the radial direction.

It can be advantageous if the rotor housing has a cap in the interior of the wheel rim, between the wall of the ring-shaped wheel rim base and the pitch circle having the attachment holes.

The cap also serves to seal off the components of the wheel hub motor from the surroundings, as tightly as possible, in order to prevent penetration of dirt or splashed water from road traffic.

It can be advantageous if the cap of the rotor housing disposed on the inner side relative to the wheel disk, which might have spokes.

In this way, it is furthermore possible to provide appealing designs on the wheel disk that has the spokes. Because the cap of the rotor housing borders on the wheel disk and is preferably connected in one piece with it, the rotor housing can furthermore be optimally cooled. The wheel disk and/or, in particular, its spokes can be configured, in terms of their geometry and/or arrangement, in such a manner that the rotor housing is successfully cooled with air during travel of the motor vehicle. Furthermore, the one-piece design ensures very good cold conduction.

It can be advantageous if the rotor housing is configured in the manner of a rotor bell composed of a cap and at least partially of a ring-shaped wall of the ring-shaped wheel rim base.

It can be advantageous if the rotor housing, particularly as an at least partially integral component of the wheel rim, is configured in one piece with the wheel rim.

Because of the fact that the screw connection otherwise required between rotor housing and wheel rim is eliminated, according to the invention, direct and more efficient transfer of force from the rotor housing to the tires takes place, with the housing having taken on the function of the wheel rim, at least in part.

It can be advantageous if the rotor housing, particularly as an at least partially integral component of the wheel rim, is cast or forged in one piece with the wheel rim.

For certain wheel rim designs, it can be advantageous if the rotor housing, particularly as an at least partially integral component of the wheel rim, is produced in one piece with the wheel rim, using gravity casting.

For specific wheel rim designs, it can be advantageous if the rotor housing, particularly as an at least partially integral component of the wheel rim, is produced in one piece with the wheel rim, using die casting.

For some wheel rim designs, it can be advantageous if the rotor housing, particularly as an at least partially integral component of the wheel rim, is produced in one piece with the wheel rim, using low-pressure casting.

For other wheel rim designs, it can be advantageous if the rotor housing, particularly as an at least partially integral component of the wheel rim, is produced in one piece with the wheel rim, using counter-pressure casting (CPC).

It can be advantageous if the rotor housing, particularly as an at least partially integral component of the wheel rim, and the wheel rim, consist of light metal, particularly of a magnesium alloy or preferably of an aluminum alloy.

Further details and advantageous embodiments of the invention are evident from the following description in connection with the drawing. This shows:

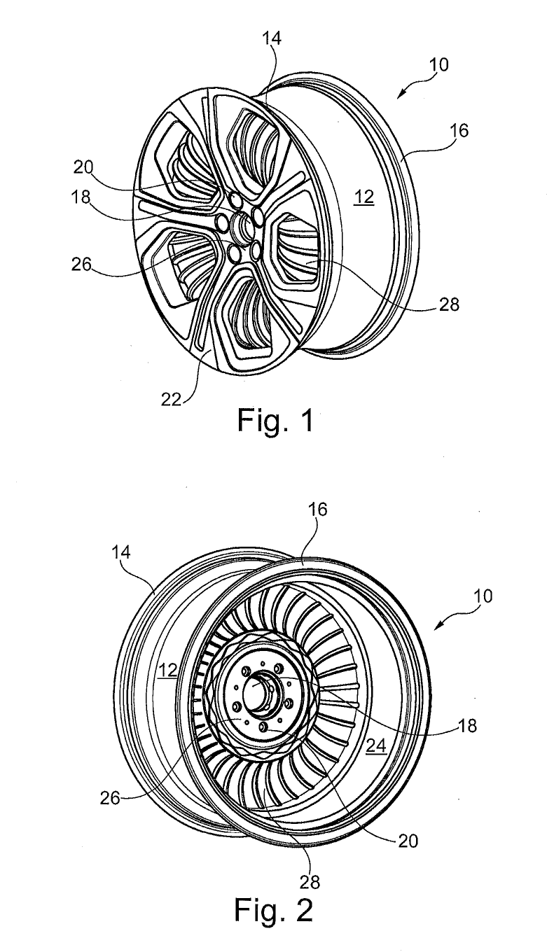

FIG. 1 schematically, in a perspective representation, a wheel rim according to the invention, having a rotor bell, in a view from the outside,

FIG. 2 schematically, in a perspective representation, a wheel rim according to the invention, having a rotor bell, in a view from the inside, and

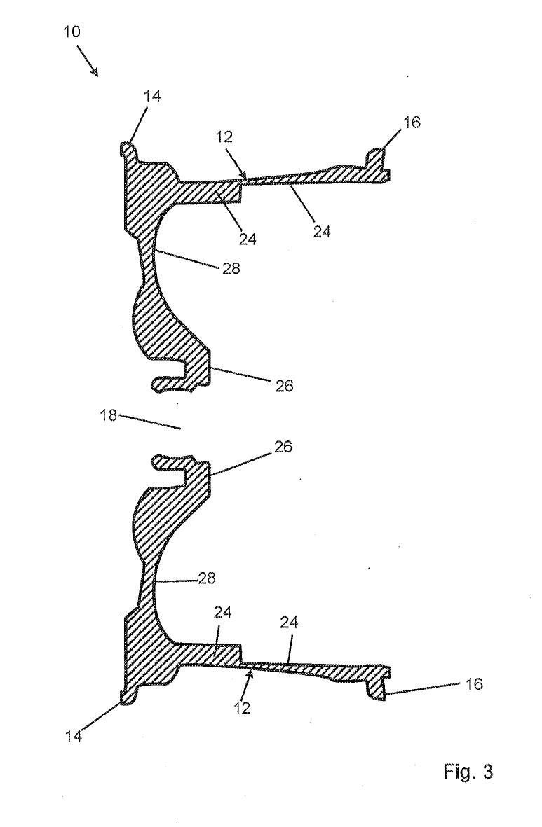

FIG. 3 schematically, a cross-section through the wheel rim according to the invention, having a rotor bell.

The wheel rim 10 shown in FIGS. 1 to 3, for motor vehicles driven with wheel hub motors, comprises a wheel rim base 12, an outer 14 and an inner 16 wheel rim flange 14, 16, and a wheel disk having a center hole 18, attachment holes 20, and spokes 22. According to the invention, at least part of the rotor housing of the wheel hub motor forms at least part of the wheel rim 10, in other words takes on the function of the wheel rim in this region.

In the present case, the rotor housing is configured in the manner of a rotor bell, composed of a cap 28 and at least partially of a ring-shaped wall 24 of the ring-shaped wheel rim base 12, wherein the cap 28 of the rotor housing is configured in the interior of the wheel rim 10, between the wall 24 of the ring-shaped wheel rim base 12 and the pitch circle 26 that has the attachment holes 20, and is disposed on the inner side relative to the wheel disk that has the spokes 22.

It is clearly evident that the rotor housing described is produced as an at least partially integral component of the wheel rim 10, in one piece with the wheel rim 10, wherein the wheel rim consists of an aluminum alloy.

### REFERENCE SYMBOL LIST

(is part of the specification)
10 wheel rim
12 wheel rim base
14 outer wheel rim flange
16 inner wheel rim flange
18 center hole
20 attachment hole
22 spoke
24 wall
26 pitch circle
28 cap

1. Wheel rim (10) for motor vehicles driven with wheel hub motors, having a wheel rim base (12), an outer (14) and an inner (16) wheel rim flange (14, 16), and a wheel disk having a center hole (18), attachment holes (20), and, if applicable, having spokes (22), wherein at least a part of the rotor housing of a wheel hub motor forms at least a part of the wheel rim (10).

2. Wheel rim (10) according to claim 1, wherein at least part of the rotor housing forms the wall (24) of the ring-shaped wheel rim base (12), at least in part.

3. Wheel rim (10) according to claim 1, wherein the rotor housing has a cap (28) in the interior of the wheel rim (10), between the wall (24) of the ring-shaped wheel rim base (12) and the pitch circle (26) having the attachment holes (20).

4. Wheel rim (10) according to claim 3, wherein the cap (28) of the rotor housing is disposed on the inner side of the wheel disk, which might have spokes (22).

5. Wheel rim (10) according to claim 1, wherein the rotor housing is configured in the manner of a rotor bell composed of a cap (28) and at least partially of a ring-shaped wall (24) of the ring-shaped wheel rim base (12).

6. Wheel rim (10) according to claim 1, wherein the rotor housing, particularly as an at least partially integral component of the wheel rim (10), is configured in one piece with the wheel rim (10).

7. Wheel rim (10) according to claim 1, wherein the rotor housing, particularly as an at least partially integral component of the wheel rim (10), is cast or forged in one piece with the wheel rim (10).

8. Wheel rim (10) according to claim 1, wherein the rotor housing, particularly as an at least partially integral component of the wheel rim (10), is produced in one piece with the wheel rim (10), using gravity casting, die casting, low-pressure casting, or counter-pressure casting.

9. Wheel rim (10) according to claim 1, wherein the rotor housing, particularly as an at least partially integral component of the wheel rim (10), and the wheel rim (10) comprise light metal, particularly an aluminum alloy.
